(19) United States
(12) Patent Application Publication
(10) Pub. No.: US 2018/0145549 A1
(43) Pub. Date: May 24, 2018

(54) ROTARY ELECTRIC MACHINE AND MANUFACTURING METHOD FOR ROTARY ELECTRIC MACHINE

(71) Applicant: Mitsubishi Electric Corporation, Chiyoda-ku, Tokyo (JP)

(72) Inventors: Tatsuro HINO, Tokyo (JP); Kohei EGASHIRA, Tokyo (JP); Tetsuya YOKOGAWA, Tokyo (JP); Shinkichi SAWA, Tokyo (JP); Akihiro YAMAMURA, Tokyo (JP); Masaya INOUE, Tokyo (JP); Akira HASHIMOTO, Tokyo (JP); Masashi NAKAMURA, Tokyo (JP)

(73) Assignee: Mitsubishi Electric Corporation, Chiyoda-ku, Tokyo (JP)

(21) Appl. No.: 15/575,124

(22) PCT Filed: Sep. 12, 2016
(86) PCT No.: PCT/JP2016/076838

§ 371 Date: Nov. 17, 2017

(30) Foreign Application Priority Data
Sep. 28, 2015 (JP) 2015-189289

(51) Int. Cl. H02K 1/18; H02K 3/14; H02K 1/16

(52) U.S. Cl. CPC H02K 1/18; H02K 1/16; H02K 3/14

(57) ABSTRACT

A rotary electric machine according to the present invention includes: a stator including an outer core, a plurality of inner cores, and a coil accommodated in slots, each slot being surrounded by opposing circumferential side surfaces of tooth portions of adjacent inner cores and by inner circumferential surfaces of projections of the adjacent inner cores; and a rotor. A gap is provided between the circumferential side surfaces of the adjacent inner cores. The coil has a first slot-accommodated portion and a second slot-accommodated portion accommodated in different slots, and a turn portion connecting the two slot-accommodated portions on one end surface, in an axial direction, of a stator core. The turn portion is elastically urged in a direction in which the first slot-accommodated portion and the second slot-accommodated portion move away from each other in the circumferential direction.

### TECHNICAL FIELD

The present invention relates to a high-output, high-quality, and inexpensively-manufacturable rotary electric machine, and a manufacturing method for the rotary electric machine.

### BACKGROUND ART

As a conventional rotary electric machine, a rotary electric machine having a structure in which the space factor of coils is increased by dividing a stator core in the radial direction to achieve high output, has been known (refer to Patent Document 1, for example). Patent Document 1 proposes a stator for a rotary electric machine, which stator is provided with an annular structure (outer core) pressing divided cores inward in the radial direction of the stator.

The stator core disclosed in Patent Document 1 includes: an annular outer core; a plurality of inner cores divided in the circumferential direction; and connection portions extending from each of tooth portions of the inner cores to both sides in the circumferential direction, thereby increasing the area of the contact surface between the outer core and each inner core. Thus, magnetic resistance between the outer core and each inner core is reduced, thereby providing an effect of increasing the output power of the rotary electric machine.

The connection portions extending from each tooth portion in the circumferential direction contact with other connection portions extending from adjacent tooth portions, whereby compression stress is generated between adjacent inner cores and the respective inner cores can be fixed to the outer core without increasing the number of components, thereby also providing an effect of inexpensively manufacturing the rotary electric machine.

### CITATION LIST

### Patent Document

Patent Document 1: Japanese Patent Publication No. 3414879

### SUMMARY OF THE INVENTION

### Problems to be Solved by the Invention

In the stator for the rotary electric machine disclosed in Patent Document 1, however, since the connection portions extending at the both sides, in the circumferential direction, of each inner core are fitted to the connection portions of other inner cores adjacent in the circumferential direction, compression stress acts between the adjacent inner cores, thus causing a problem that iron loss is increased. In addition, in order to appropriately control the stress acting on the contact surface, accuracy of a die is required and therefore the life of the die is shortened, thus causing a problem that the manufacturing cost of the rotary electric machine is increased.

On the other hand, in a structure in which the connection portions of the inner cores adjacent in the circumferential direction are not fitted to each other in the circumferential direction, the inner cores cannot be fixed, and therefore, the outer core and the inner cores need to be fixed by special fixing means such as welding, adhesion, resin filling, or the like, thus causing a problem that the material cost and manufacturing cost of the rotary electric machine are increased.

The present invention has been made to solve the above problems, and an object of the present invention is to provide a high-output, high-quality, and inexpensively-manufacturable rotary electric machine, and a manufacturing method for the rotary electric machine.

### Solution to the Problems

A rotary electric machine according to the present invention includes:

a stator including
a cylindrical outer core,
a plurality of inner cores arranged in a circumferential direction of the outer core along an inner circumferential surface of the outer core, each inner core having a tooth portion and projections extending in the circumferential direction from a radially outward end portion of the tooth portion, and
a coil accommodated in slots, each slot being surrounded by opposing circumferential side surfaces of the tooth portions of the adjacent inner cores and by inner circumferential surfaces of the projections of the adjacent inner cores; and

a rotor rotatably supported inside the stator, wherein

a gap is provided between circumferential side surfaces of at least two adjacent inner cores,

the coil has a first slot-accommodated portion and a second slot-accommodated portion accommodated in different slots, and a turn portion connecting the first slot-accommodated portion with the second slot-accommodated portion, on one end surface, in an axial direction, of a stator core composed of the outer core and the inner cores, and

the turn portion is elastically urged in a direction in which the first slot-accommodated portion and the second slot-accommodated portion move away from each other in the circumferential direction.

A manufacturing method for the above-mentioned rotary electric machine according to the present invention is a manufacturing method for a rotary electric machine including:

a stator including
a cylindrical outer core,
a plurality of inner cores arranged in a circumferential direction of the outer core along an inner circumferential surface of the outer core, each inner core having a tooth portion and projections extending in the circumferential direction from a radially outward end portion of the tooth portion, and
a coil accommodated in slots, each slot being surrounded by opposing circumferential side surfaces of the tooth portions of the adjacent inner cores and by inner circumferential surfaces of the projections of the adjacent inner cores; and

a rotor rotatably supported inside the stator, wherein

a gap is provided between circumferential side surfaces of at least two adjacent inner cores, and

the coil has a first slot-accommodated portion and a second slot-accommodated portion accommodated in different slots, and a turn portion connecting the first slot-accommodated portion with the second slot-accommodated portion, on one end surface, in an axial direction, of a stator core composed of the outer core and the inner cores, and

the method includes:

a coil manufacturing process of forming the coil in advance such that a width of the turn portion in the circumferential direction is larger than a width thereof when the coil is mounted in the slot;

a stator winding manufacturing process of assembling a plurality of the coils to form a coil basket;

an inner core arranging process of arranging the inner cores outside the coil basket;

an inner core inserting process of holding the inner cores and moving the inner cores radially inward, and inserting all the inner cores into the coil basket while contracting the width of the turn portion of each coil; and

an outer core inserting process of inserting, in the axial direction, the outer core on the outer circumferential side of the coil basket in which the inner cores are inserted.

### Effect of the Invention

According to the rotary electric machine of the present invention, since the adjacent inner cores are not fitted to each other in the circumferential direction, stress acting on the adjacent inner cores is reduced, and hysteresis loss due to an AC magnetic field is reduced, thereby realizing an increase in the efficiency of the rotary electric machine.

### BRIEF DESCRIPTION OF THE DRAWINGS

Since the inner cores are not fitted to each other in the circumferential direction, the cost for managing a die for the inner cores can be reduced. Further, since fixing means such as adhesion need not be used, the number of components and the number of steps can be reduced to improve productivity of the rotary electric machine.

According to the manufacturing method for the rotary electric machine of the present invention, since the inner cores are inserted from the outer circumferential side to the stator winding formed by assembling the plurality of coils, the stator winding can be formed in advance so as to have dimensions close to predetermined dimensions, and therefore, an unnecessarily great force does not act between the stator core and the stator winding. Thus, reliability regarding insulation between the coil and the stator core can be improved.

FIG. 1 is a perspective view of a rotary electric machine according to Embodiment 1 of the present invention.

FIG. 2 is a cross-sectional view of the rotary electric machine according to Embodiment 1 of the present invention.

FIG. 3 is a plan view of a stator according to Embodiment 1 of the present invention, as viewed in the axial direction.

FIG. 4 is an enlarged view of a portion enclosed by a circle in FIG. 3.

FIG. 5 is a perspective view of a coil according to Embodiment 1 of the present invention.

FIG. 6 is a plan view of the coil according to Embodiment 1 of the present invention, as viewed from above in the axial direction.

FIG. 7 is a front view of the coil according to Embodiment 1 of the present invention, as viewed from radially inner side.

FIG. 8 is a conceptual diagram schematically showing arrangement of slot-accommodated portions of the coil in slots, according to Embodiment 1 of the present invention.

FIG. 9 is a schematic diagram showing one turn portion of the coil and two slot-accommodated portions connected to this turn portion, as viewed from radially inner side, according to Embodiment 1 of the present invention.

FIG. 10 is a schematic diagram showing states before and after insertion of a portion of the coil into a slot, according to Embodiment 1 of the present invention.

FIG. 11 is a front schematic diagram showing only parts of turn portions and slot-accommodated portions of three coils, as viewed from radially inner side of the stator, according to Embodiment 1 of the present invention.

FIG. 12 is a schematic cross-sectional view taken along an A-A line in FIG. 11.

FIG. 13 is an enlarged view of a portion enclosed by a circle in FIG. 12.

FIG. 14 is a perspective view of a stator winding formed by assembling coils according to Embodiment 1 of the present invention.

FIG. 15 is a perspective view showing a state in which 48 inner cores are arranged around the stator winding in the circumferential direction, according to Embodiment 1 of the present invention.

FIG. 16 is a perspective view showing a state after the inner cores are inserted in the stator winding, according to Embodiment 1 of the present invention.

FIG. 17 is a perspective view showing a state after an outer core is mounted on the outer side of the inner cores.

FIG. 18 is a plan view of a stator according to Embodiment 2 of the present invention, as viewed in the axial direction.

FIG. 19 is an enlarged view of a portion enclosed by a circle in FIG. 18.

FIG. 20 is a plan view of a stator according to Embodiment 3 of the present invention, as viewed in the axial direction.

FIG. 21 is an enlarged view of a portion enclosed by a circle in FIG. 20.

FIG. 22 is a plan view of a stator according to Embodiment 4 of the present invention, as viewed in the axial direction.

FIG. 23 is an enlarged view of a portion enclosed by a circle in FIG. 22.

FIG. 24 is a perspective view of a stator according to Embodiment 5 of the present invention.

FIG. 25 is a perspective view of a stator according to Embodiment 6 of the present invention.

FIG. 26 is a plan view of the stator according to Embodiment 6 of the present invention, as viewed in the axial direction.

FIG. 27 is an enlarged view of a portion enclosed by a circle in FIG. 26.

FIG. 28 shows an example of a state in the vicinity of a slot bottom according to Embodiment 1 of the present invention.

FIG. 29 shows an example of a state in the vicinity of a slot bottom according to Embodiment 6 of the present invention.

### DESCRIPTION OF EMBODIMENTS

### Embodiment 1

Hereinafter, a rotary electric machine and a manufacturing method for the rotary electric machine according to Embodiment 1 of the present invention will be described with reference to the drawings.

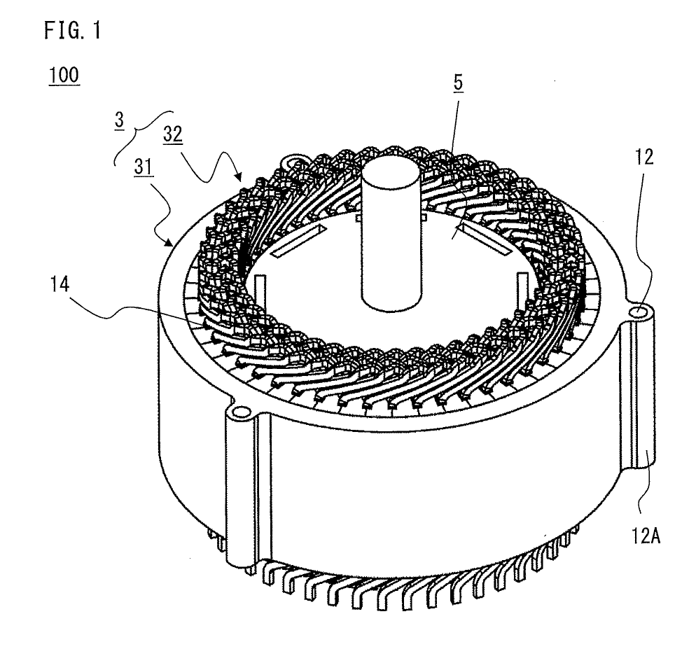

FIG. 1 is a perspective view of a rotary electric machine 100.

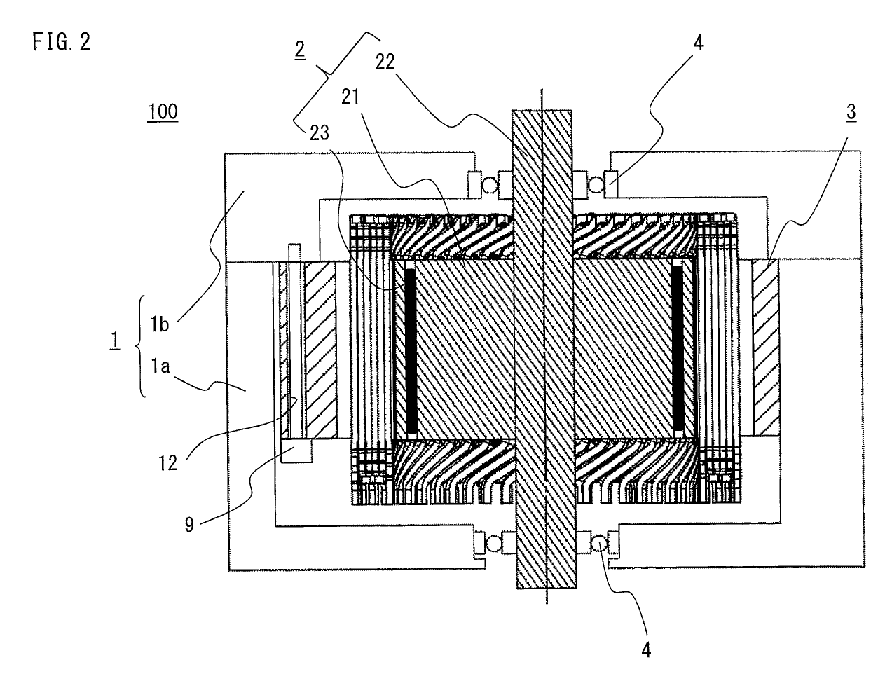

FIG. 2 is a cross-sectional view of the rotary electric machine 100.

In this description, unless otherwise particularly mentioned, the terms “axial direction”, “circumferential direction”, “radial direction”, “inner circumferential side”, “outer circumferential side”, “inner circumferential surface”, and “outer circumferential surface” refer to the “axial direction”, “circumferential direction”, “radial direction”, “inner circumferential side”, “outer circumferential side”, “inner circumferential surface”, and “outer circumferential surface” of a stator, respectively. In this description, unless otherwise particularly mentioned, the terms “up” and “down” refer to, when a plane perpendicular to the axial direction is assumed in a reference place, a side including a center point of the stator and a side opposite thereto with the plane being a boundary, respectively. In comparing the levels of height, the longer the distance from the center of the stator is, the “higher” the level of height is.

The rotary electric machine 100 includes: a housing 1 having a bottomed cylindrical frame 1a and a bracket 1b closing an opening of the frame 1a; a stator 3 fastened to the bracket 1b by means of a bolt 9; and a rotor 2 rotatably supported, on the inner circumferential side of the stator 3, via bearings 4 at the center of a bottom portion of the frame 1a and the center of the bracket 1b.

The rotor 2 includes: a rotor core 21; a rotary shaft 22 inserted and fixed at an axial position of the rotor core 21; and a plurality of permanent magnets 23 which are embedded near an outer circumferential surface of the rotor core 21 to be arranged at a predetermined pitch in the circumferential direction, and form magnetic poles. The rotor 2 is not limited to a permanent magnet type rotor. The rotor 2 may be a squirrel cage rotor in which non-insulated rotor conductors are accommodated in slots of a rotor core and are short-circuited at both sides by short-circuit rings, or may be a wound rotor in which insulated conductive wires are mounted to slots of a rotor core.

Next, the configuration of the stator 3 will be described with reference to the drawings. As shown in FIG. 1, the stator 3 includes: a stator core 31; a stator winding 32 (coil basket) mounted to the stator core 31; and an insulation sheet 14 (insulating member) electrically insulating the stator winding 32 from the stator core 31.

The stator winding 32 is formed by connecting a plurality of coils 5. That is, an aggregation of the coils 5 is the stator winding 32.

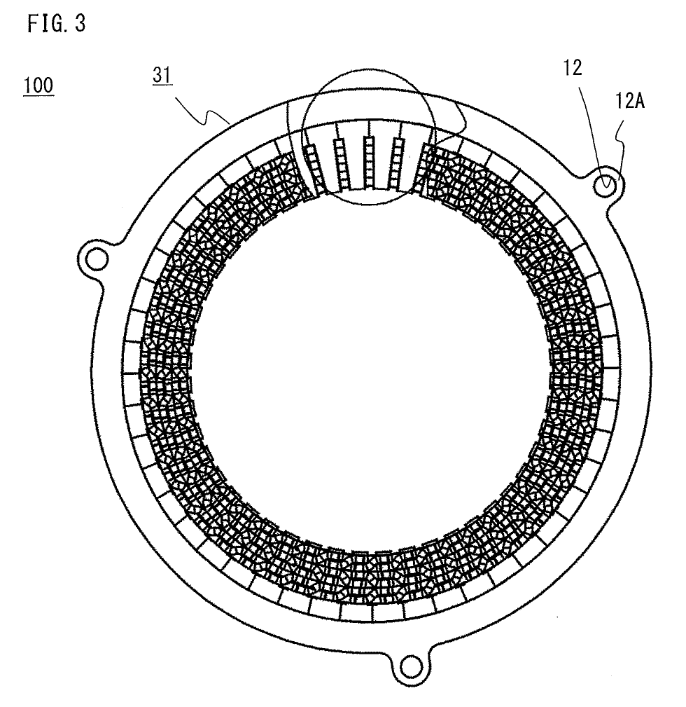

FIG. 3 is a plan view of the rotary electric machine 100 as viewed in the axial direction. A portion enclosed by a circle includes a cross-sectional view perpendicular to the axial direction.

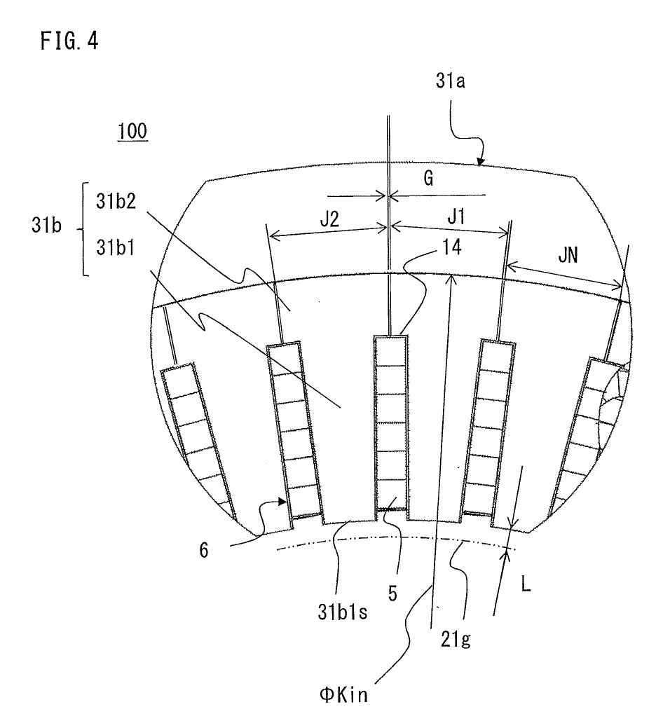

FIG. 4 is an enlarged view of the portion enclosed by the circle in FIG. 3.

For convenience of explanation, the number of poles of the stator 3 is 8, the number of slots of the stator core 31 is 48, and the stator winding 32 is a three-phase winding. Therefore, two slots 6 are formed per pole and per phase in the stator core 31.

The stator core 31 is composed of: a cylindrical outer core 31a; and a plurality of inner cores 31b arranged in the circumferential direction along the inner circumferential surface of the outer core 31a. Each inner core 31b includes: a tooth portion 31b1 extending radially inward; and two projections 31b2 extending from a radially outer end portion of the tooth portion 31b1 toward both sides in the circumferential direction. Each of slots 6 for accommodating the coils 5 is formed so as to be surrounded by the opposing circumferential side surfaces of the tooth portions 31b1 of adjacent inner cores 31b and by the inner circumferential surfaces of the projections 31b2 of the adjacent inner cores 31b. The insulation sheet 14 for electrically insulating the coils 5 from the stator core 31 is accommodated along an inner wall surface of each slot 6. The insulation sheet 14 being accommodated between the coils 5 and the inner core 31b prevents edge portions of the inner core 31b and the coils 5 from directly contacting with each other, thereby providing an effect of improving mutual insulating property. Each of the outer core 31a and the inner cores 31b of the stator core 31 is formed by stacking and integrating a predetermined number of electromagnetic steel sheets. A stator core formed from an arbitrary magnetic material such as a powder magnetic core may be adopted.

The outer core 31a has attachment holes 12 for fixing the stator core 31 in the housing 1. Since the stator core 31 has the attachment holes 12, it is not necessary to fix the stator core 31 by fixing means such as shrink-fitting or press-fitting, thereby improving productivity. In addition, since compression stress caused by fitting described later does not act on the outer core 31a, hysteresis loss due to an AC magnetic field is reduced, thereby increasing the efficiency of the rotary electric machine. Further, in the divided cores represented by the present embodiment, rigidity of the stator core tends to decrease as compared to a single-piece core. However, rigidity of the stator core 31 is improved by providing attachment portions 12A, each having the attachment hole 12, at which the radial width of the outer core is increased. Fixing of the stator core 31 is not limited to the fixing using the attachment holes 12, and the stator core 31 may be fixed so as to be fitted to the frame 1a.

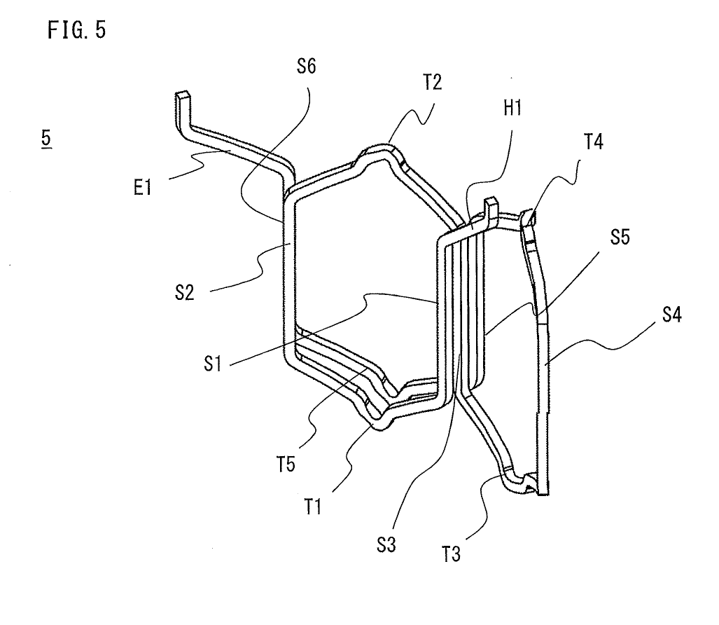

Next, the configuration of the stator winding 32 will be described with reference to the drawings. FIG. 5 is a perspective view of a coil 5 which is a minimum unit for forming the stator winding 32.

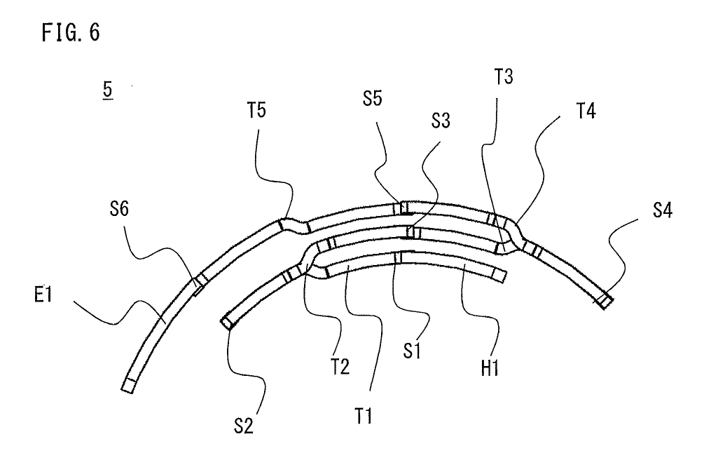

FIG. 6 is a plan view of the coil 5 as viewed from above in the axial direction.

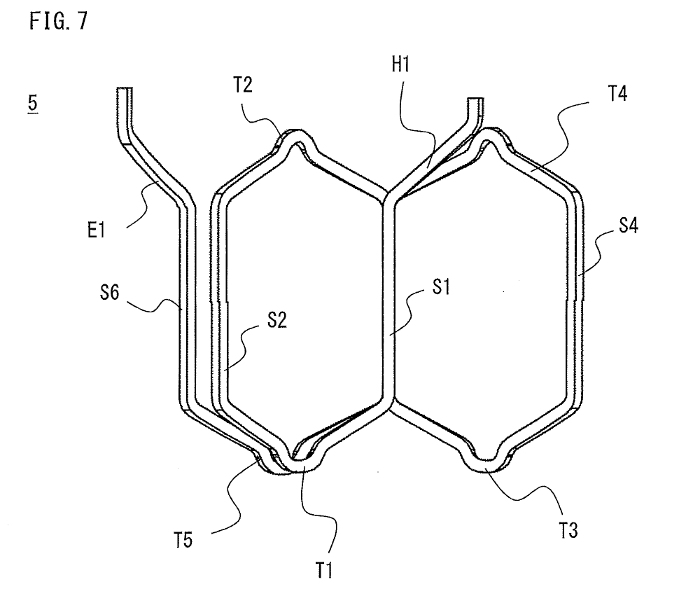

FIG. 7 is a front view of the coil 5 as viewed from radially inner side.

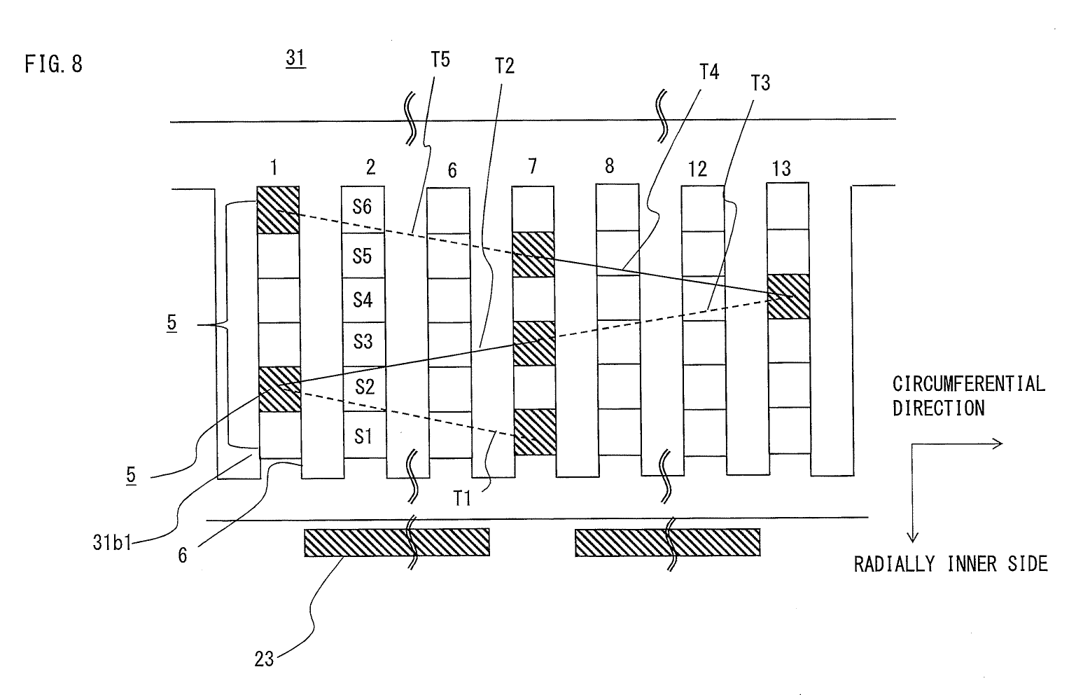

FIG. 8 is a conceptual diagram schematically showing arrangement of slot-accommodated portions S1 to S6 of the coil 5 in the slots 6.

As shown in FIGS. 3, 4 and 8, 48 slots 6 are formed between the respective adjacent inner cores 31b of the stator core 31. The coil 5 has a shape obtained by winding, in a figure-of-eight shape as viewed from radially inner side, a continuous conductive wire that is formed from copper, aluminum, or the like and has an insulating coating of an enamel resin, for example. When copper is adopted as a material of the coil 5, it is desirable to use oxygen-free copper when the coil 5 is welded. Using oxygen-free copper can inhibit occurrence of blowholes during welding, thereby providing an effect of improving reliability of welded portions. Alternatively, a copper alloy, such as Cu—Zr, having excellent thermal conductivity may be adopted. Using such a material having excellent thermal conductivity provides an effect of improving heat dissipation of the coil 5.

The coil 5 is composed of: slot-accommodated portions S1 to S6 to be accommodated in each slot 6; turn portions T1 to T5 each being extended from one slot 6 and accommodated in another slot 6; and terminal portions H1 and E1 at both ends of the coil 5. A first slot-accommodated portion and a second slot-accommodated portion in claims are in a relationship that, for example, when the slot-accommodated portion S6 is the first slot-accommodated portion, the slot-accommodated portion S5 is the second slot-accommodated portion.

As shown in FIG. 8, in each slot 6, the slot-accommodated portions S1 to S6 of the coil 5 are accommodated so as to be regularly aligned in the radial direction. In FIG. 8, numbers appended to the top of the respective slots 6 are serial numbers of the slots 6 for convenience of explanation. The third to fifth slots 6 and the ninth to eleventh slots 6 are not shown. The positions, in the second slot 6, to which numbers S1 to S6 are appended, are radial positions in which the respective slot-accommodated portions S1 to S6 are accommodated. Hereinafter, the positions in which the respective slot-accommodated portions S1 to S6 of the coil 5 are accommodated will be illustrated and described, focusing on only one coil 5.

Specifically, the slot-accommodated portion S1 of a certain coil 5 is accommodated at the position S1 in the seventh slot 6. The conductive wire extended out from the seventh slot 6 to the back side on the drawing sheet of FIG. 8 becomes the turn portion T1 (shown by a broken line) on one end surface of the stator core 31 and is continuously connected to the slot-accommodated portion S2 accommodated at the position S2 in the first slot 6. Then, the conductive wire extended out from the first slot 6 to the front side on the drawing sheet of FIG. 8 becomes the turn portion T2 (shown by a solid line) and is continuously connected to the slot-accommodated portion S3 accommodated at the position S3 in the seventh slot 6.

Then, the conductive wire extended out from the seventh slot 6 to the back side on the drawing sheet of FIG. 8 becomes the turn portion T3 (shown by a broken line) and is continuously connected to the slot-accommodated portion S4 accommodated at the position S4 in the thirteenth slot 6.

Then, the conductive wire extended out from the thirteenth slot 6 to the front side on the drawing sheet of FIG. 8 becomes the turn portion T4 (shown by a solid line) and is continuously connected to the slot-accommodated portion S5 accommodated at the position S5 in the seventh slot 6.

Then, the conductive wire extended out from the seventh slot 6 to the back side on the drawing sheet of FIG. 8 becomes the turn portion T5 (shown by a broken line) and is continuously connected to the slot-accommodated portion S6 accommodated at the position S6 in the first slot 6. In this way, the respective slot-accommodated portions S1 to S6 of the coil 5 are sequentially accommodated at positions different by one conductive wire in the radial direction, in another slot 6 separated in the circumferential direction by one magnetic pole pitch (across 6 slots in this embodiment) via the turn portions T1 to T5. In addition, the terminal portion H1 connected to the slot-accommodated portion S1 and the terminal portion E1 connected to the slot-accommodated portion S6 are connected to the terminal portions H1 or E1 of another coil 5 or to a neutral point or a power feed portion by connection means such as welding.

48 pieces of coils 5 configured as described above are arranged in the circumferential direction, and predetermined connection is performed to form the stator winding 32.

Next, configuration features of the inner cores 31b will be described with reference to the drawings.

As shown in FIG. 4, at least one set of portions of the projections 31b2 of the adjacent inner cores 31b are not in contact with each other in the circumferential direction, and a gap G is provided therebetween. Since the projections 31b2 are not in contact with each other in the circumferential direction, compression stress is not applied in the circumferential direction between any adjacent inner cores 31b. Thus, stress acting on the stator core 31 is reduced, and hysteresis loss due to an AC magnetic field is reduced, thereby increasing the efficiency of the rotary electric machine 100.

Since the widths and angles of the circumferential opposing surfaces of the adjacent projections 31b2 need not be controlled more strictly than necessary, manufacturing costs can be reduced. Further, as compared to the case where the adjacent inner cores 31b are fitted to each other in the circumferential direction, the stacked layers in each inner core are not electrically short-circuited with each other in the stacking direction, eddy current loss of the core is reduced to achieve high efficiency.

The inner cores 31b are arranged in the circumferential direction inside the outer core 31a such that the gap G between the adjacent inner cores 31b is greater than 0. At this time, assuming that the division number of the inner cores 31b in the circumferential direction is N, the outer circumferential lengths of the N inner cores 31b are J1, J2, . . . , JN as shown in FIG. 4, and the inner diameter of the outer core 31a is Kin, ΣJN(=J1+J2+ . . . +JN)<π·Kin is satisfied. When the outer core 31a and the inner cores 31b have the dimensions described above, the gap G can be reliably ensured by only controlling the outer core 31a and the inner cores 31b independently from each other, whereby the rotary electric machine 100 can be manufactured inexpensively.

The position of a two-dotted dashed line 21g in FIG. 4 is the position of the outer circumferential surface of the rotor 2 disposed inside the stator 3. It is desirable that the magnitude relationship between the gap G and an air gap L between the outer circumferential surface of the rotor core 21 and an inner end portion 31b is of the tooth portion 31b1 of the inner core 31b is L>G. When the air gap L and the gap G satisfy the above relationship, influence of the magnetic resistance due to the gap G is relatively small, in comparison between the magnetic resistance due to the air gap L and the magnetic resistance due to the gap G, whereby cogging torque and torque ripple can be reduced.

The gap G may be provided so as to be dispersed over the entire circumference in the circumferential direction. When the gap G is dispersed over the entire circumference, the magnetic resistances in the circumferential direction between the respective tooth portions 31b1 are made uniform as compared to the case where the gap G is provided to be concentrated to one position, whereby cogging torque and torque ripple can be reduced.

Next, a dimensional relationship of the coil 5 in order to press the coil 5 against the projections 31b2 in the radial direction will be described with reference to the drawings.

In the present invention, the outer core 31a and the inner cores 31b are not fitted to each other as described above. In this state, the inner cores 31b cannot be fixed to the inner circumferential surface of the outer core 31a. Therefore, each inner core 31b is fixed to the inner circumferential surface of the outer core 31a by the coil 5 while utilizing the repulsive force of the coil 5 and the shape of the slot 6.

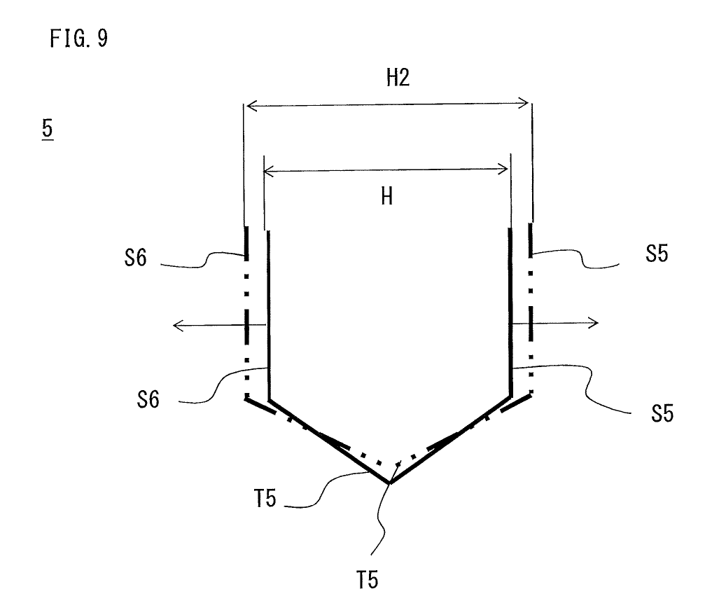

FIG. 9 is a schematic diagram showing one turn portion T5 of the coil 5 and two slot-accommodated portions S6 and S5 connected to the turn portion T5, as viewed from radially inner side.

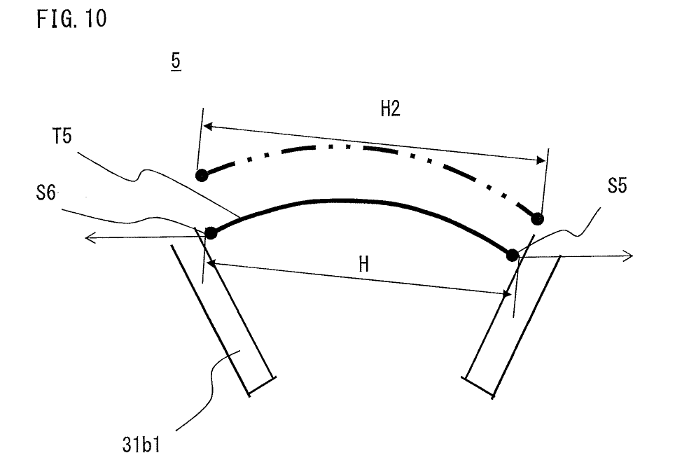

FIG. 10 is a schematic diagram showing states before and after insertion of a portion of the coil 5 shown in FIG. 9 into a slot, as viewed in the axial direction.

In FIGS. 9 and 10, H indicates a pitch (width) in the circumferential direction when the coil 5 is inserted into the slot, and corresponds to one magnetic pole pitch. Likewise, H2 indicates a pitch in the circumferential direction in FIGS. 9 and 10 when the coil 5 is formed in advance. The pitch H2 in the circumferential direction when the coil 5 is formed is set to satisfy H<H2.

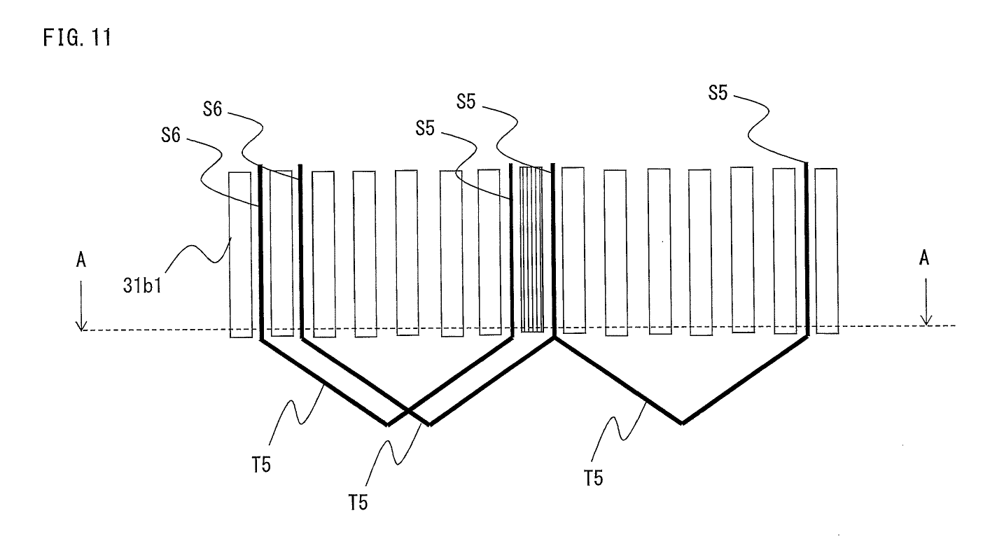

FIG. 11 is a front schematic diagram showing only the slot-accommodated portions S5 and S6 and the turn portions T5 of three coils 5, as viewed from radially inner side of the stator 3.

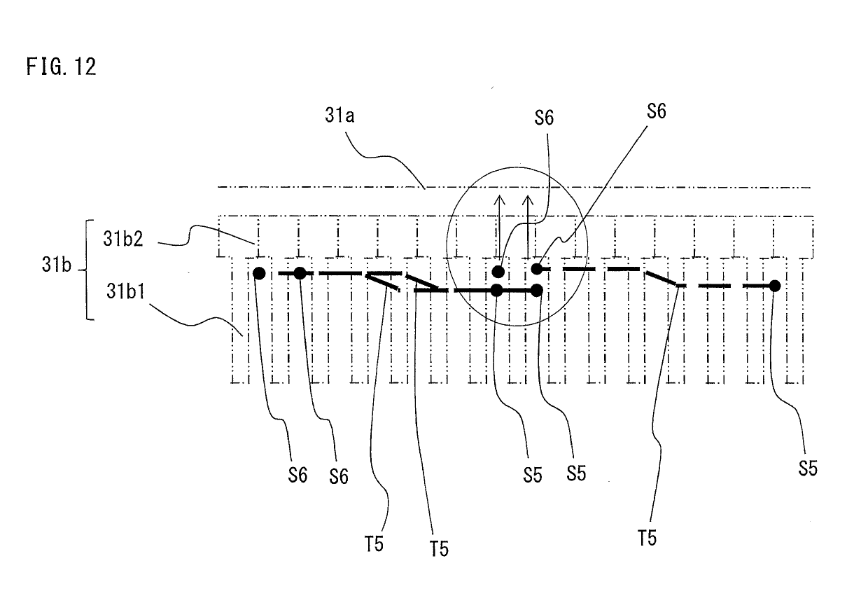

FIG. 12 is a schematic cross-sectional view taken along an A-A line in FIG. 11.

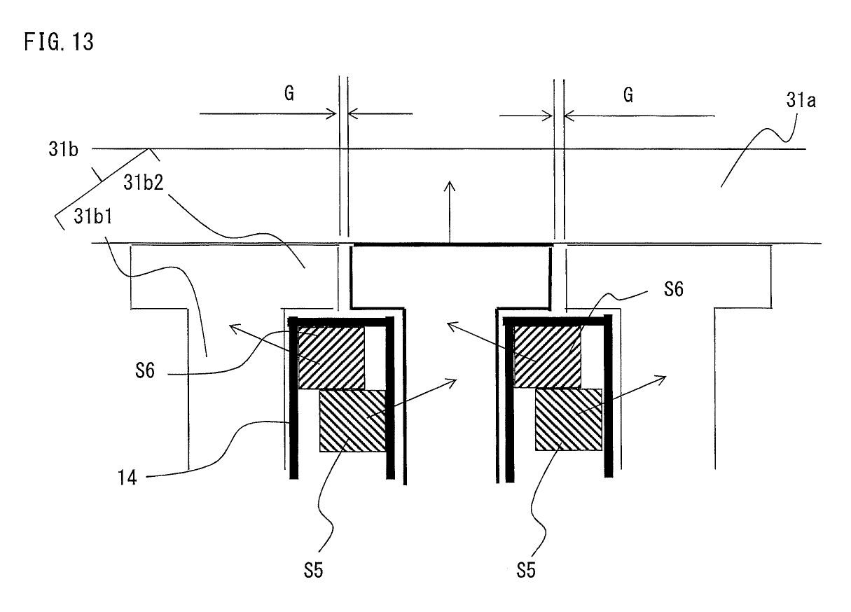

FIG. 13 is an enlarged view of a portion enclosed by a circle in FIG. 12.

In FIGS. 12 and 13, only the slot-accommodated portion S6 of the fourth coil 5 is also shown for convenience of explanation.

Although the outer core 31a is actually formed in a cylindrical shape and the inner cores 31b and the coil 5 are actually formed in arc shapes, these components are illustrated in plane shapes in FIGS. 11 to 13 for convenience of explanation.

The coil 5 is manufactured in advance such that the circumferential width of the turn portions T1 to T5 are greater than those of when the coil 5 is accommodated in the slot 6. In this case, when the coil 5 is accommodated in the slot 6, each of the turn portions T1 to T5 is elastically urged, and generates a force of expanding outward in the circumferential direction (repulsive force of spring).

That is, when the turn portion T5, which is compressed to reduce its width by being inserted into the slot 6, expands in the circumferential direction as shown by arrows in FIG. 9, the slot-accommodated portions S5 and S6 expand outward in the circumferential direction. Actually, the two slots 6 in which the slot-accommodated portions S5 and S6 are accommodated are in a positional relationship of being relatively separated from each other toward the outer circumferential side, and therefore, the slot-accommodated portions S5 and S6 attempt to move in directions away from each other as shown by arrows in FIG. 13. As a result, the slot-accommodated portion S6 moves radially outward along the side wall of the slot 6, collides against the projection 31b2 via the insulation sheet 14, and presses the projection 31b2 radially outward. Then, the slot-accommodated portion S5 of another coil 5 presses, radially outward, the aforementioned slot-accommodated portion S6 located radially outward. Although illustration and description are omitted here, each of other slot-accommodated portions S1 to S4 also moves radially outward along the inner wall of the slot 6, whereby the whole slot-accommodated portions S1 to S6 press the projection 31b2 radially outward. The outer circumferential surface of the inner core 31b which receives this pressing force is further pressed against the inner circumferential surface of the outer core 31a located outside the inner core 31b.

Since all the inner cores 31b receive the radially outward force caused by the repulsive force of the coil 5, and are pressed against the inner circumferential surface of the outer core 31a, even when the gap G exists between the projections 31b2 of the adjacent inner cores 31b, the inner cores 31b can be fixed. With this configuration, the inner cores 31b can be fixed without using other fixing means such as welding or adhesion, whereby the rotary electric machine 100 can be inexpensively manufactured.

The direction in which the slot-accommodated portion S6 presses the inner core 31b diagonally outward in the circumferential direction and the direction in which the slot-accommodated portion S5 presses the inner core 31b diagonally outward in the circumferential direction are opposite from each other in the circumferential direction. Therefore, the inner cores 31b are strongly fixed radially outward by the resultant force, whereby vibration and noise of the rotary electric machine 100 can be reduced.

A cushioning material containing, for example, an epoxy-based resin or the like, may be provided between the contact surfaces of the inner cores 31b and the outer core 31a. Providing the cushioning material can further reduce the vibration and noise. In addition, the cushioning material is desirably an insulating material such as an epoxy-based material or an acryl-based material. Using the insulating material prevents electrical short-circuiting between the inner cores 31b and the outer core 31a in the axial direction, whereby eddy current loss that occurs in the stator core 31 can be inhibited. Alternatively, a magnetic material such as a powder core may be used as the cushioning material. Using the powder core allows fine gaps present between the inner cores 31b and the outer core 31a to be filled with the magnetic material, whereby magnetic resistance of the stator core 31 can be reduced to increase the output power of the rotary electric machine 100.

The axial length of each inner core 31b is desirably not greater than the axial length of the outer core 31a. In this case, each inner core 31b is prevented from projecting, in the axial direction, from the axial end surface of the outer core 31a, and therefore, a portion in which the inner core 31b is not in contact with the outer core 31a in the radial direction is eliminated, thereby increasing the fixing strength.

While the coil 5 according to the present embodiment has the six slot-accommodated portions S1 to S6, the minimum unit of the coil to be used may be composed of at least two slot-accommodated portions and one elastic turn portion connecting these slot-accommodated portions.

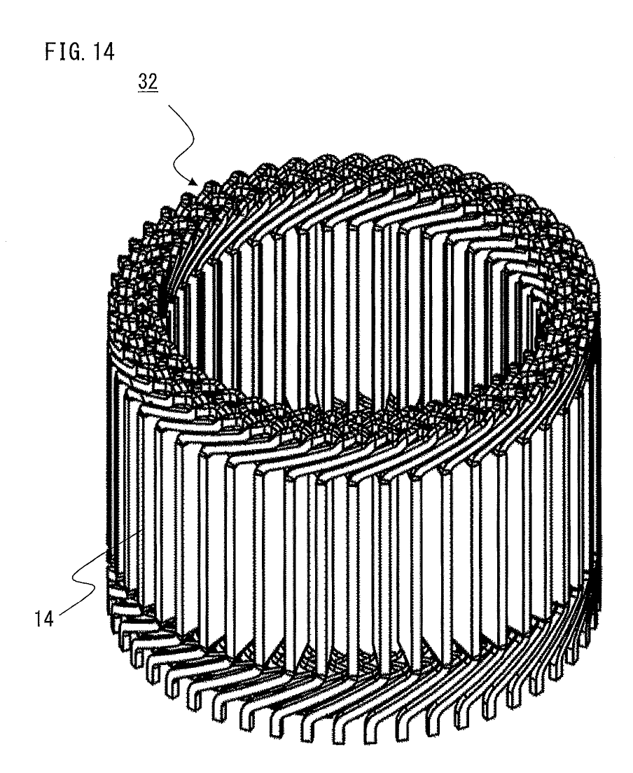

Next, a manufacturing method for the rotary electric machine 100 according to the present embodiment will be described with reference to FIGS. 14 to 17.

FIG. 14 is a perspective view of a stator winding 32 formed by assembling 48 coils 5.

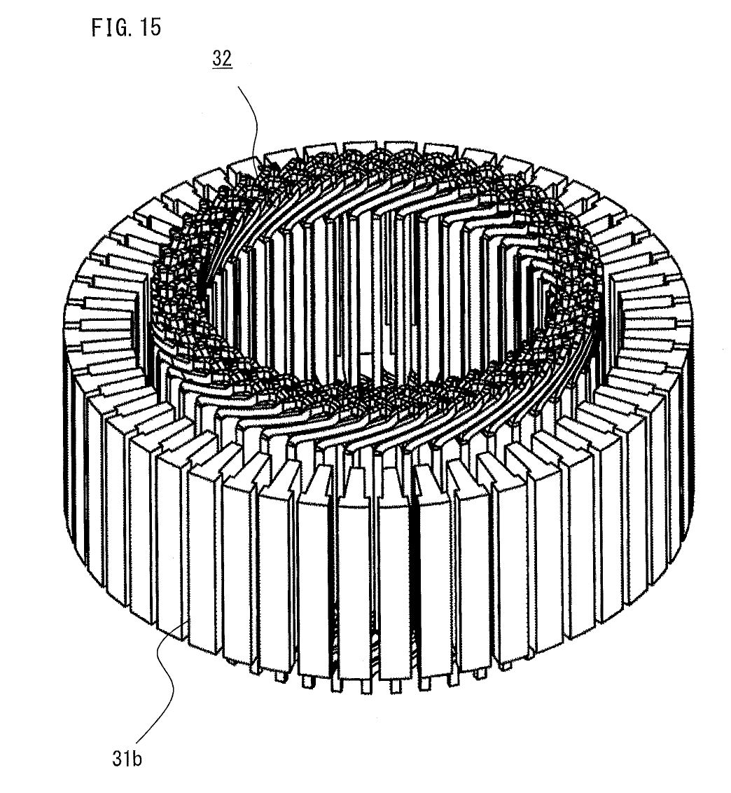

FIG. 15 is a perspective view showing a state in which 48 inner cores 31b are arranged around the stator winding 32 in the circumferential direction.

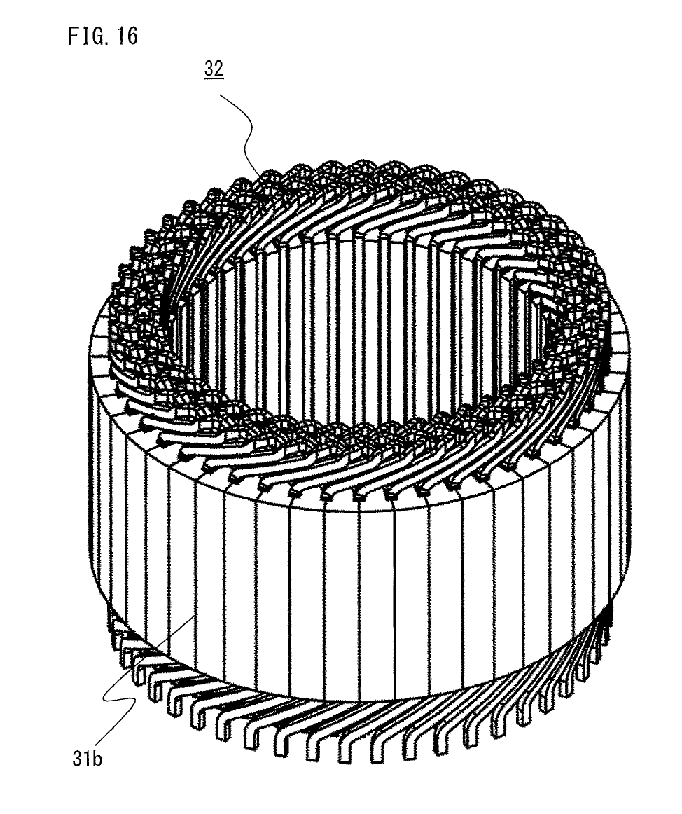

FIG. 16 is a perspective view showing a state after the inner cores 31b are inserted in the stator winding 32.

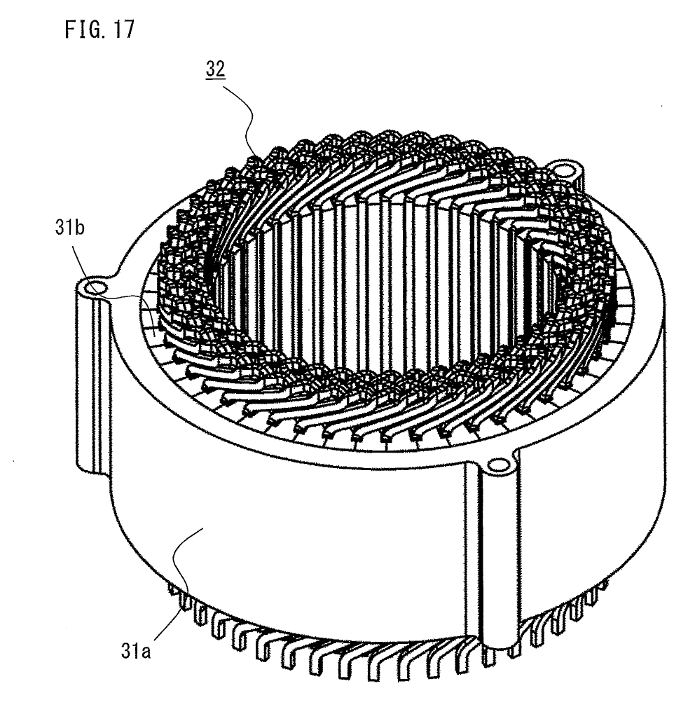

FIG. 17 is a perspective view showing a state after the outer core 31a is mounted on the outer side of the inner cores 31b.

First, 48 coils 5 shown in FIG. 9 are manufactured (coil manufacturing process). At this time, the width of the turn portions T1 to T5 is greater than the width of the turn portions T1 to T5 at the time when the rotary electric machine 100 is completed. Next, as shown in FIG. 14, the 48 coils 5 are combined in the circumferential direction to assemble the stator winding 32 (stator winding manufacturing process). Next, the insulation sheet 14 for electrically insulating the coil 5 from the stator core 31 is attached to the stator winding 32 (insulation sheet inserting process). Next, as shown in FIG. 15, the inner cores 31b are arranged on the outer circumferential side of the stator winding 32 so as to surround the stator winding 32 evenly and radially (inner core arranging process). Thereafter, all the inner cores 31b are held by a holding tool (not shown), are moved radially inward such that all the inner cores 31b are evenly reduced in diameter as shown in FIG. 16, and are inserted into the stator winding 32 (inner core inserting process). At this time, the width of each of the turn portions T1 to T5 connecting two slot-accommodated portions of each coil 5 is reduced and thereby each turn portion is elastically urged.

Next, the outer core 31a is inserted on the outer side of the inner cores 31b in the axial direction (outer core inserting process). Thereafter, when holding of the inner cores 31b by the holding tool described above is released, the widths of all the turn portions T1 to T5 are extended, whereby the respective coils 5 press the inner cores 31b radially outward as described above, and thus the inner cores 31b can be fixed to the inner circumferential surface of the outer core 31a (inner core fixing process).

According to the rotary electric machine 100 of Embodiment 1 of the present invention and the manufacturing method for the rotary electric machine 100, since the gap G prevents the adjacent inner cores 31b from being fitted to each other in the circumferential direction, stress acting on the inner cores 31b is reduced, and hysteresis loss due to an AC magnetic field is reduced, thereby realizing an increase in the efficiency of the rotary electric machine 100.

Since the inner cores 31b are not fitted to each other in the circumferential direction, the cost for managing a die for the inner cores 31b can be reduced. Further, since fixing means such as adhesion need not be used, the number of components and the number of steps can be reduced to improve productivity of the rotary electric machine 100.

Since the inner cores 31b are inserted from the outer circumferential side to the stator winding 32 obtained by assembling a plurality of coils 5, the stator winding 32 can be formed in advance so as to have dimensions close to predetermined dimensions, and therefore, an unnecessarily great force does not act between the stator core 31 and the stator winding 32. Thus, reliability regarding insulation between the coils 5 and the stator core 31 can be improved.

### Embodiment 2

Hereinafter, a rotary electric machine and a rotary electric machine manufacturing method according to Embodiment 2 of the present invention will be described focusing on differences from Embodiment 1.

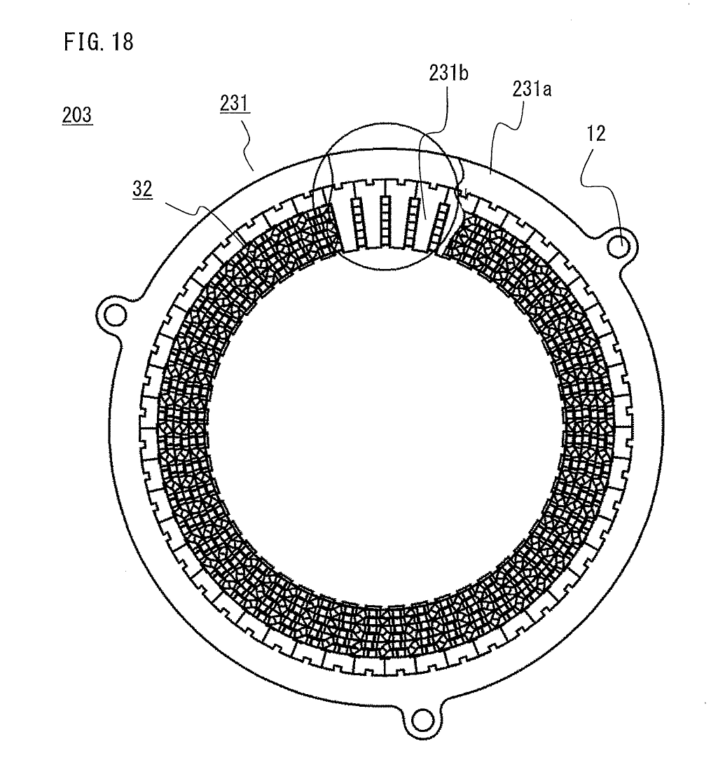

FIG. 18 is a plan view of a stator 203 as viewed in the axial direction. A portion enclosed by a circle includes a cross-sectional view perpendicular to the axial direction.

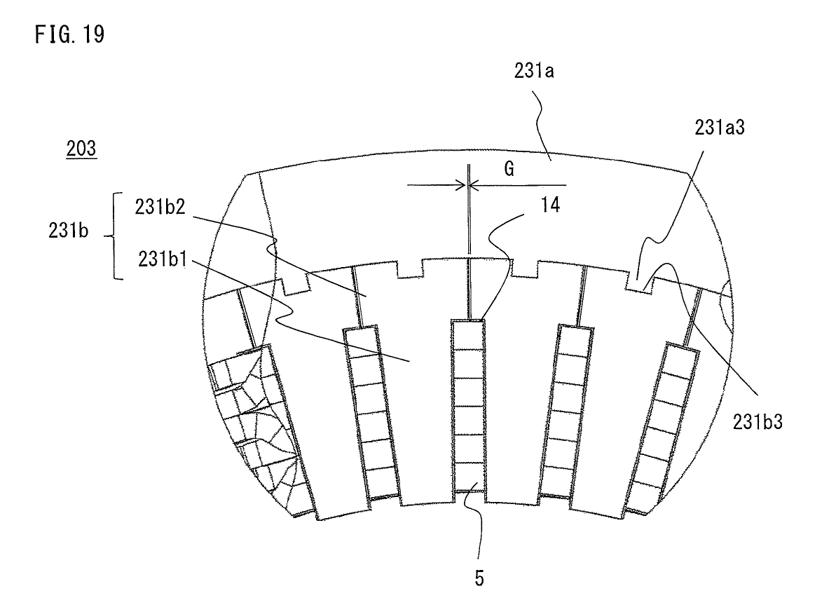

FIG. 19 is an enlarged view of the portion enclosed by the circle in FIG. 18.

An inner circumferential surface of an outer core 231a of the present embodiment has projections 231a3 (positioning portions) projecting radially inward and extending in the axial direction. The projections 231a3 are engaged with recesses 231b3 (positioning portions) provided in the axial direction on outer circumferential surfaces of inner cores 231b, thereby to determine the positions of the inner cores 231b in the circumferential direction. As in Embodiment 1, a gap G is provided between the faces, opposed to each other in the circumferential direction, of the projections 231b2 projecting from the adjacent inner cores 231b in the circumferential direction. A gap is also provided between each recess 231b3 and the corresponding projection 231a3 to prevent these portions from fitting to each other.

According to the rotary electric machine and the rotary electric machine manufacturing method of Embodiment 2 of the present invention, since the recesses 231b3 and the projections 231a3 for determining the positions of the inner cores 231b in the circumferential direction are provided, pitch accuracy of tooth portions 231b1 in the circumferential direction is improved, whereby cogging torque and torque ripple can be reduced. The recess-projection relationship described above may be reversed.

### Embodiment 3

Hereinafter, a rotary electric machine and a rotary electric machine manufacturing method according to Embodiment 3 of the present invention will be described focusing on differences from Embodiments 1 and 2.

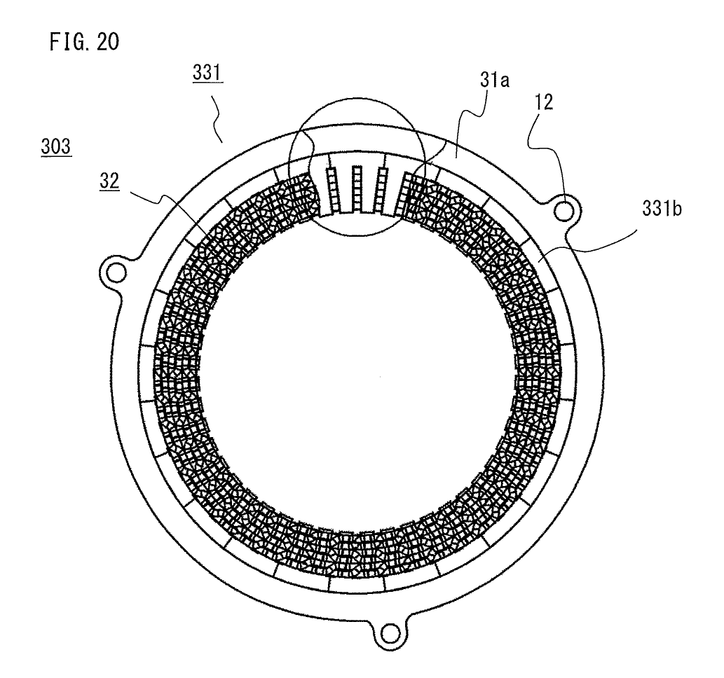

FIG. 20 is a plan view of a stator 303 as viewed in the axial direction. A portion enclosed by a circle includes a cross-sectional view perpendicular to the axial direction.

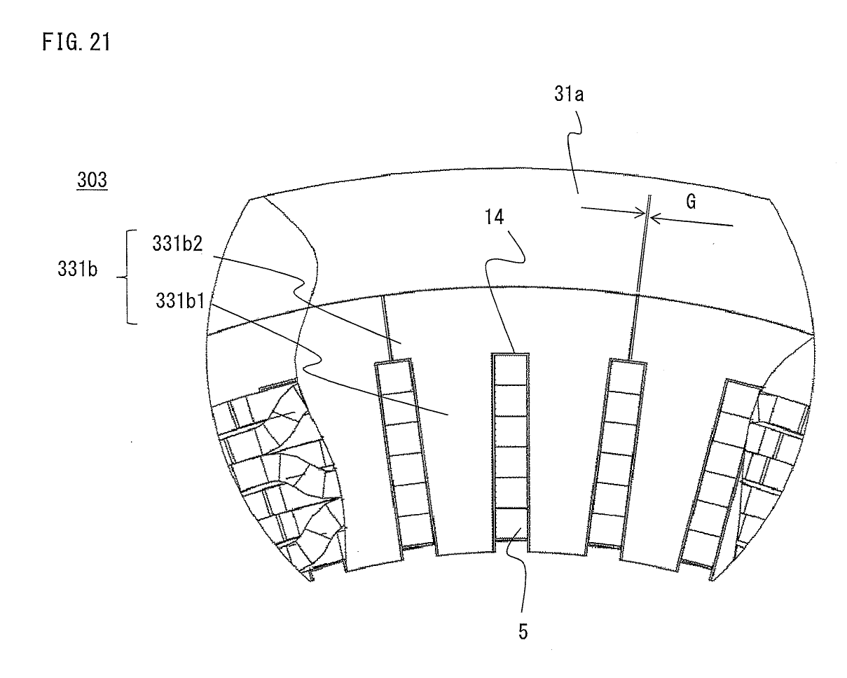

FIG. 21 is an enlarged view of the portion enclosed by the circle in FIG. 20.

Each of inner cores 331b according to the present embodiment is shaped so as to have two tooth portions 331b1 obtained by integrating adjacent inner cores 31b described in Embodiment 1. This configuration reduces the number of components, thereby improving productivity of the rotary electric machine.

### Embodiment 4

Hereinafter, a rotary electric machine and a rotary electric machine manufacturing method according to Embodiment 4 of the present invention will be described focusing on differences from Embodiments 1 to 3.

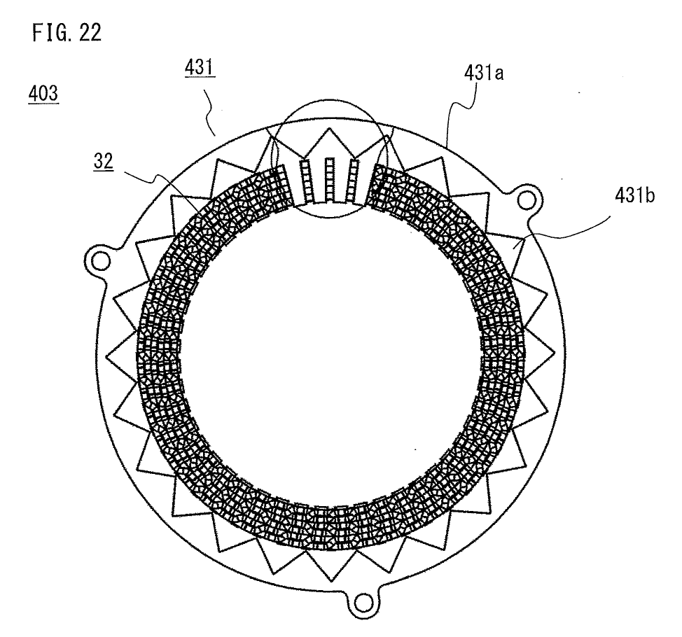

FIG. 22 is a plan view of a stator 403 as viewed in the axial direction. A portion enclosed by a circle includes a cross-sectional view perpendicular to the axial direction.

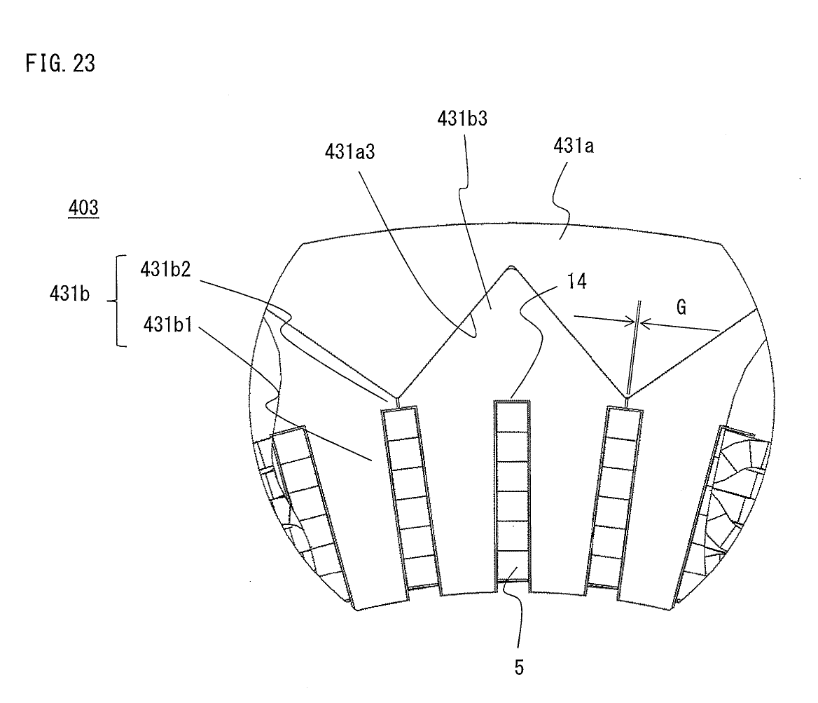

FIG. 23 is an enlarged view of the portion enclosed by the circle in FIG. 22. The portion enclosed by the circle includes a cross-sectional view perpendicular to the axial direction.

As in Embodiment 3, each of inner cores 431b has two tooth portions 431b1. At an inner circumferential surface of an outer core 431a, V-shaped recesses 431a3 (grooves) are formed in the axial direction such that a cross-section, perpendicular to the axial direction, of each V-shaped recess 431a3 is gradually narrowed toward the outer circumferential side. At an outer circumferential surface of each inner core 431b, a projection 431b3 having a V-shaped cross-section perpendicular to the axial direction is formed in the axial direction so as to abut along the corresponding recess 431a3 of the outer core 431a.

According to the rotary electric machine and the rotary electric machine manufacturing method of Embodiment 4 of the present invention, since the inner circumferential surface of the outer core 431a and the outer circumferential surface of each inner core 431b are shaped as described above, each inner core 431b is accurately positioned in the circumferential direction by pressing the inner core 431b radially outward by the coil 5, whereby the positional accuracy of each tooth portion 431b1 in the circumferential direction can be improved. Thus, cogging torque and torque ripple of the rotary electric machine can be reduced.

While the present embodiment has been described using the inner core 431b having two tooth portions 431b1 as in Embodiment 3, the present embodiment can also be combined with the inner core having one tooth portion 31b1 as in Embodiment 1.

### Embodiment 5

Hereinafter, a rotary electric machine and a rotary electric machine manufacturing method according to Embodiment 5 of the present invention will be described focusing on differences from Embodiments 1 to 4.

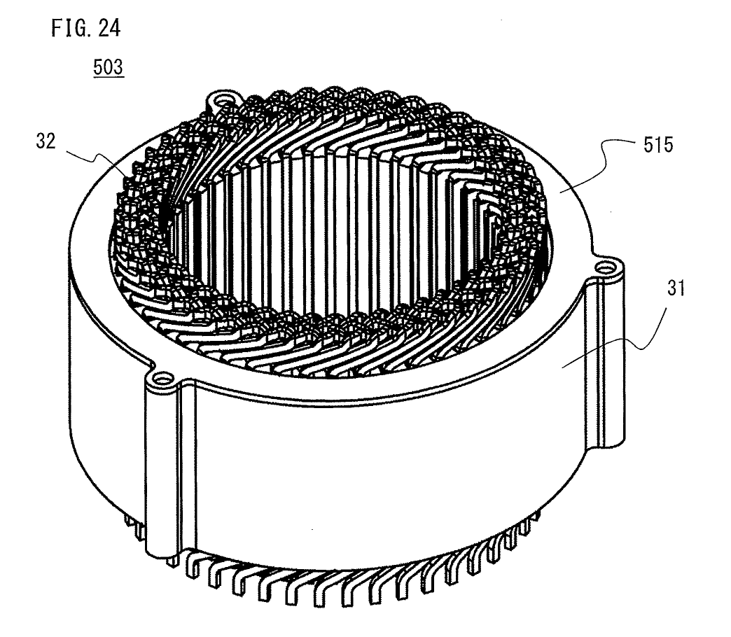

FIG. 24 is a perspective view of a stator 503. The stator 503 includes an end plate 515 which presses at least one end surface of the stator core 31 in the axial direction.

According to the rotary electric machine and the rotary electric machine manufacturing method of Embodiment 5 of the present invention, since the end plate 515 is provided, rigidity of the stator core 531 is improved, thereby inhibiting vibration and noise of the rotary electric machine.

### Embodiment 6

Hereinafter, a rotary electric machine and a rotary electric machine manufacturing method according to Embodiment 6 of the present invention will be described focusing on differences from Embodiments 1, 5.

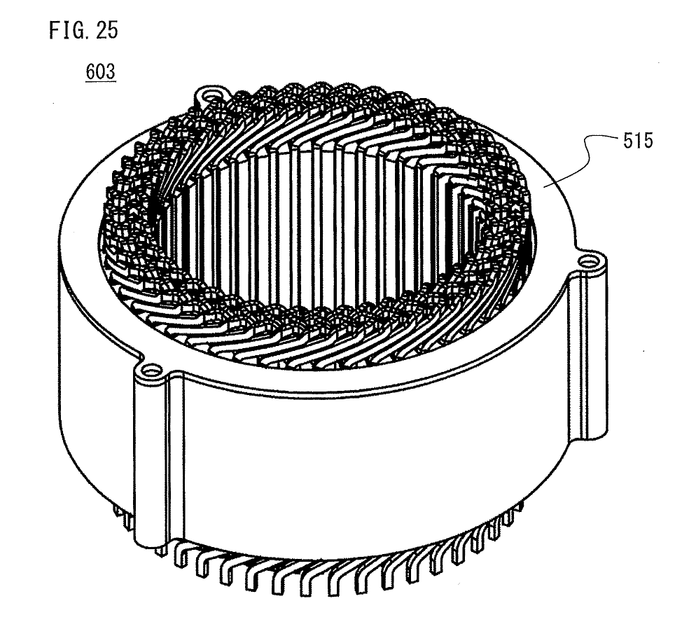

FIG. 25 is a perspective view of a stator 603.

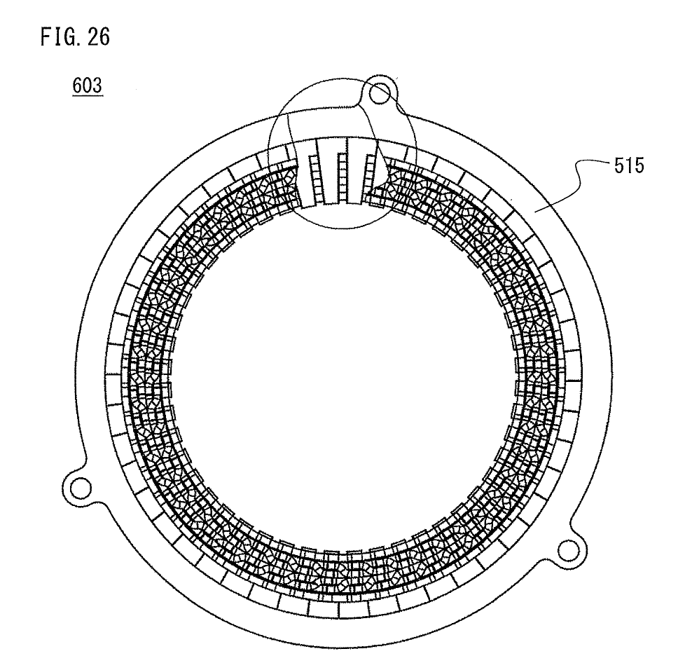

FIG. 26 is a plan view of the stator 603 as viewed in the axial direction. A portion enclosed by a circle includes a cross-sectional view perpendicular to the axial direction.

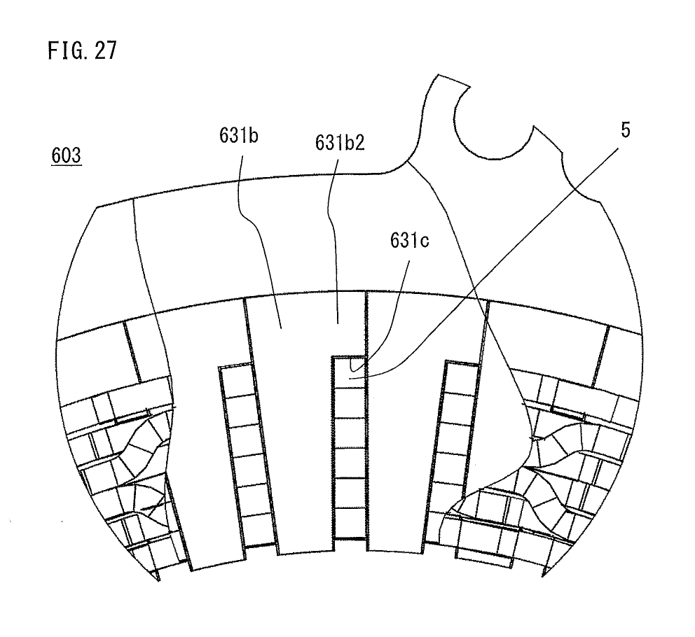

FIG. 27 is an enlarged view of a portion enclosed by a circle in FIG. 26.

As shown in FIG. 27, each inner core 631b has a projection 631b2 extending in the circumferential direction, only at one side thereof in the circumferential direction. When the inner core 631b is configured as described above, the inner core 631b does not have a circumferential division surface at a slot bottom 631c.

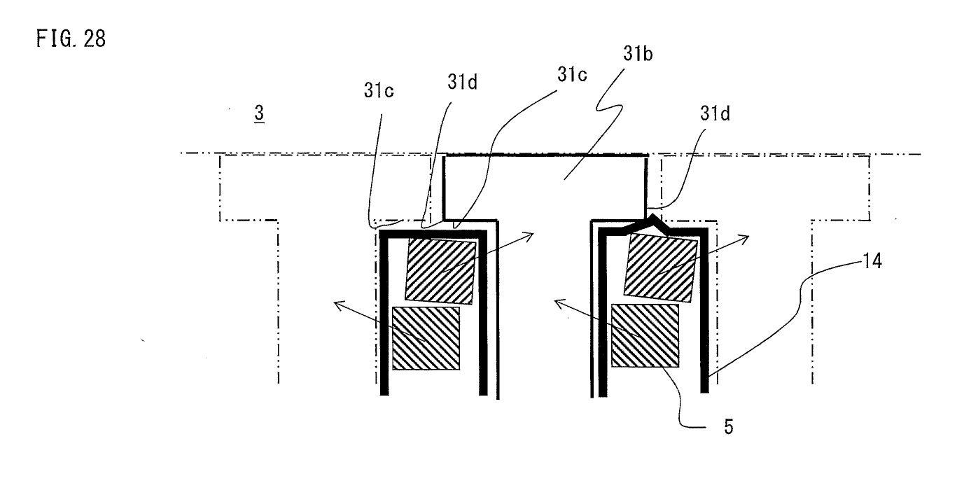

FIG. 28 shows an example of a state, in the vicinity of a slot bottom 31c, of the stator 3 according to Embodiment 1.

In Embodiment 1, as shown in FIG. 28, a circumferential division surface 31d of the inner core 31b is present at the slot bottom 31c. Therefore, the slot bottom 31c is divided into two parts in the axial direction at the center thereof. In a case where the insulation sheet 14 is formed from a thin and soft material, if a wrinkle or the like is generated in the insulation sheet 14, the wrinkle or the like may be caught between the division surfaces 31d of adjacent inner cores 31b.

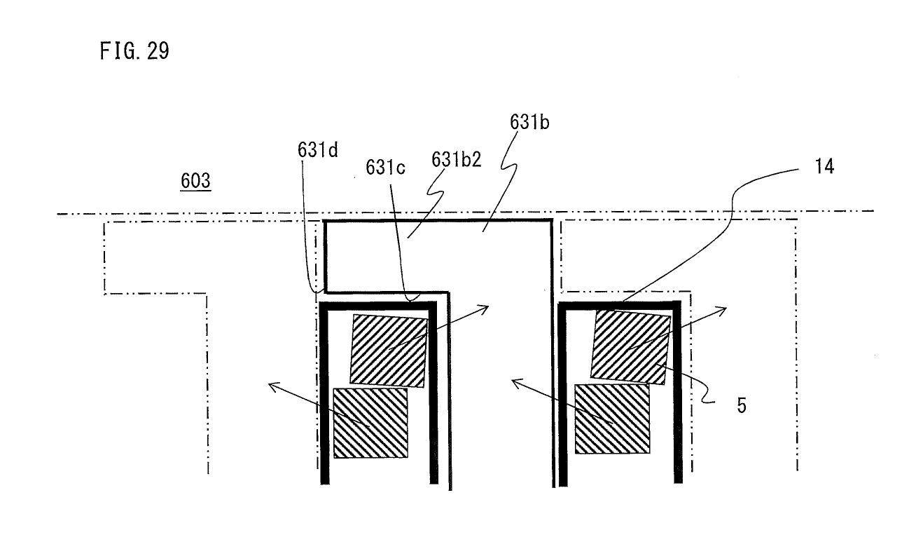

FIG. 29 is a diagram showing a state, in the vicinity of the slot bottom 631c, of the stator 603 according to the present embodiment. As shown in FIG. 29, since the inner core 631b has no circumferential division surface at the slot bottom 631c, even when the insulation sheet 14 is pressed radially outward by the coil 5, the insulation sheet 14 is not caught between adjacent inner cores 631b. Therefore, the insulation sheet 14 is prevented from being torn, thereby providing an effect that reliability of the rotary electric machine is improved. In addition, since the defect that the insulation sheet 14 is caught is avoided, the operation rate of the facility is improved, thereby providing an effect that productivity of the rotary electric machine is improved.

It is noted that, within the scope of the present invention, the above embodiments may be freely combined with each other, or each of the above embodiments may be modified or simplified as appropriate.

1. A rotary electric machine comprising:
a stator including
a cylindrical outer core,
a plurality of inner cores arranged in a circumferential direction of the outer core along an inner circumferential surface of the outer core, each inner core having a tooth portion and projections extending in the circumferential direction from a radially outward end portion of the tooth portion, and
a coil accommodated in slots, each slot being surrounded by opposing circumferential side surfaces of the tooth portions of the adjacent inner cores and by inner circumferential surfaces of the projections of the adjacent inner cores; and
a rotor rotatably supported inside the stator, wherein
a gap is provided between circumferential side surfaces of at least two adjacent inner cores,
the coil has a first slot-accommodated portion and a second slot-accommodated portion accommodated in different slots, and a turn portion connecting the first slot-accommodated portion with the second slot-accommodated portion, on one end surface, in an axial direction, of a stator core composed of the outer core and the inner cores, and
the turn portion is elastically urged in a direction in which the first slot-accommodated portion and the second slot-accommodated portion move away from each other in the circumferential direction.

2. The rotary electric machine according to claim 1, wherein
in the slots in which the first slot-accommodated portion and the second slot-accommodated portion are respectively accommodated, the first slot-accommodated portion and the second slot-accommodated portion are accommodated at positions different by one conductive wire of the coil in the radial direction.

3. The rotary electric machine according to claim 1 or 2, wherein
assuming that a division number of the inner cores in the circumferential direction is N, outer circumferential lengths of the N inner cores are J1, J2, . . . , JN, and an inner diameter of the outer core is Kin, ΣJN<π·Kin is satisfied.

4. The rotary electric machine according to claim 1, wherein
the gap is smaller than an air gap between an outer circumferential surface of a rotor core of the rotor and an inner end portion of the tooth portion of the inner core.

5. The rotary electric machine according to claim 1, wherein
the inner cores and the outer core include positioning portions for determining positions, in the circumferential direction, of the inner cores on the inner circumferential surface of the outer core.

6. The rotary electric machine according to claim 5, wherein the positioning portions are: grooves extending in the axial direction and each having a V-shaped cross-section perpendicular to the axial direction; and projections contacting with the grooves and each having a V-shaped cross-section perpendicular to the axial direction.

7. The rotary electric machine according to claim 1, wherein each inner core has two or more tooth portions.

8. The rotary electric machine according to claim 1, wherein a cushioning material is provided between the inner cores and the outer core.

9. The rotary electric machine according to claim 1, wherein the stator core and the coils are insulated from each other by an insulating member.

10. The rotary electric machine according to claim 1, wherein the outer core is provided with an attachment hole, extending in the axial direction, for attaching the stator to a housing.

11. The rotary electric machine according to claim 1, wherein an end plate is provided on at least one end surface, in the axial direction, of the stator core.

12. The rotary electric machine according to claim 1, wherein the projection is provided only at one side, in the circumferential direction, from the radially outward end portion of the tooth portion.

13. A manufacturing method for a rotary electric machine including:
a stator including
a cylindrical outer core,
a plurality of inner cores arranged in a circumferential direction of the outer core along an inner circumferential surface of the outer core, each inner core having a tooth portion and projections extending in the circumferential direction from a radially outward end portion of the tooth portion, and
a coil accommodated in slots, each slot being surrounded by opposing circumferential side surfaces of the tooth portions of the adjacent inner cores and by inner circumferential surfaces of the projections of the adjacent inner cores; and
a rotor rotatably supported inside the stator, wherein
a gap is provided between circumferential side surfaces of at least two adjacent inner cores, and
the coil has a first slot-accommodated portion and a second slot-accommodated portion accommodated in different slots, and a turn portion connecting the first slot-accommodated portion with the second slot-accommodated portion, on one end surface, in an axial direction, of a stator core composed of the outer core and the inner cores,
the method comprising:
a coil manufacturing process of forming the coil in advance such that a width of the turn portion in the circumferential direction is larger than a width thereof when the coil is mounted in the slot;
a stator winding manufacturing process of assembling a plurality of the coils to form a coil basket;
an inner core arranging process of arranging the inner cores outside the coil basket;
an inner core inserting process of holding the inner cores and moving the inner cores radially inward, and inserting all the inner cores into the coil basket while contracting the width of the turn portion of each coil; and
an outer core inserting process of inserting, in the axial direction, the outer core on the outer circumferential side of the coil basket in which the inner cores are inserted.
